(19) United States
(12) Patent Application Publication
(10) Pub. No.: US 2025/0363916 A1
(43) Pub. Date: Nov. 27, 2025

(54) REFLECTIVE LIGHT-EMITTING DIODE SIGN

(71) Applicant: Raymond Ferrer, Moreno Valley, CA (US)

(72) Inventor: Raymond Ferrer, Moreno Valley, CA (US)

(21) Appl. No.: 18/672,201

(22) Filed: May 23, 2024

(51) Int. Cl. G09F 13/16; G09F 13/00; G09F 13/22

(52) U.S. Cl. CPC G09F 13/16; G09F 13/005; G09F 13/22; G09F 2013/222

(57) ABSTRACT

A reflective LED sign includes a housing, a wiring assembly, and a plurality of LED bulbs. The housing includes rear panel, side panels, and a front panel, wherein the front panel includes a reflective surface designed to amplify the brightness of LED bulbs and a plurality of orifices. The wiring assembly is positioned within the housing. The LED bulbs project out through the orifices and are operatively connected to the wiring assembly.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to illuminated signs and more particularly pertains to a new reflective light-emitting diode (LED) sign that includes a reflective surface to amplify the brightness of LED bulbs to increase the visual attraction of a sign for advertising or other communication purposes.

### (2) Description of Related Art Including Information Disclosed Under 37 CFR 1.97 and 1.98

The prior art relates to illuminated signs. The prior art, as best understood, does not disclose a reflective LED sign that includes a front panel with LED bulbs projecting out of the front panel, wherein the front panel has a reflective surface to amplify the brightness of LED bulbs to increase the visual attraction of a sign for advertising or other communication purposes.

### BRIEF SUMMARY OF THE INVENTION

An embodiment of the disclosure meets the needs presented above in a reflective LED sign generally comprising a housing, a wiring assembly, and a plurality of LED bulbs. The housing includes rear panel, side panels, and a front panel, wherein the front panel includes a reflective surface designed to amplify the brightness of LED bulbs and a plurality of orifices. The wiring assembly is positioned within the housing. The LED bulbs project out through the orifices and are operatively connected to the wiring assembly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a reflective LED sign according to an embodiment of the disclosure.

FIG. 2 is a rear perspective view of an embodiment of the disclosure.

FIG. 3 is a side cross-sectional view of an embodiment of the disclosure.

FIG. 4 is a close-up view of a component of an embodiment of the disclosure.

FIG. 5 is a front view of an embodiment of the disclosure in use.

### DETAILED DESCRIPTION OF THE INVENTION

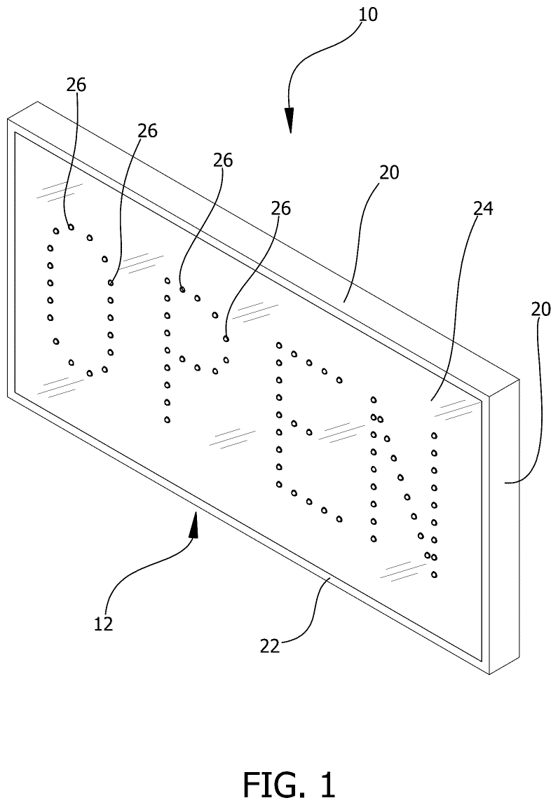

With reference now to the drawings, and in particular to FIGS. 1 through 5 thereof, a new reflective LED sign embodying the principles and concepts of an embodiment of the disclosure and generally designated by the reference numeral 10 will be described.

As best illustrated in FIGS. 1 through 5, the reflective LED sign 10 generally comprises a housing 12, a wiring assembly 14, and a plurality of LED bulbs 16. The housing 12 includes rear panel 18, side panels 20, and a front panel 22, wherein the front panel 22 includes a reflective surface 24 designed to amplify the brightness of LED bulbs 16 and a plurality of orifices 26. The wiring assembly 14 is positioned within the housing 12. The LED bulbs 16 project out through the orifices 26 and are operatively connected to the wiring assembly 14. The LED bulbs 16 are designed to present at least one color, such as a single color or multiple different colors.

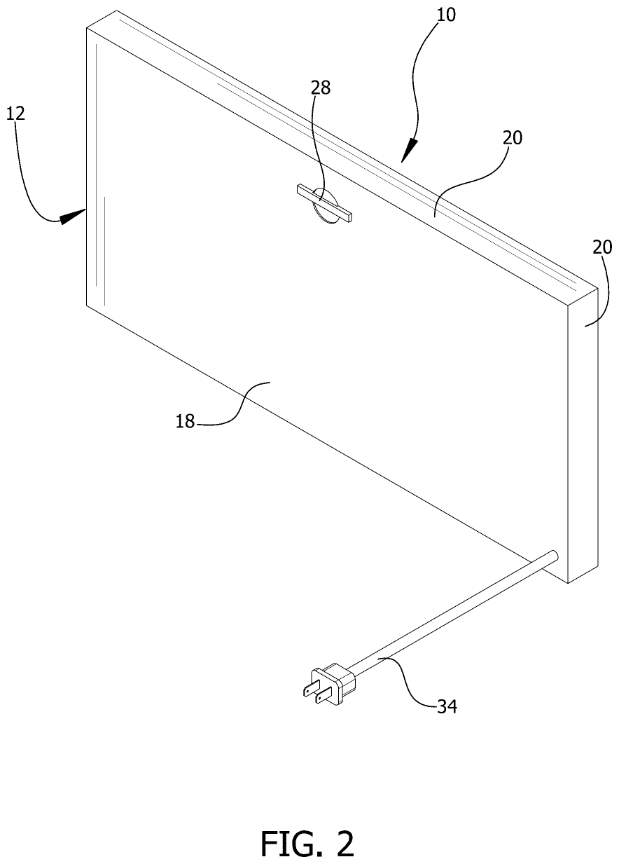

As shown in FIG. 1, the orifices 26 are arranged to present alphanumeric characters, in this case the word “OPEN.” In at least one possible embodiment, the orifices 26 can be arranged to present any image, such as words, numbers, shapes or outlines of objects or beings, or any other image to be communicated to a viewer. The reflective surface 24 can be essentially any reflective material, such as a shiny metal. In at least one possible embodiment, the reflective surface 24 is a mirror. The rear panel 18 includes a wall mount assembly 28, such as a mounting bracket as shown in FIG. 2.

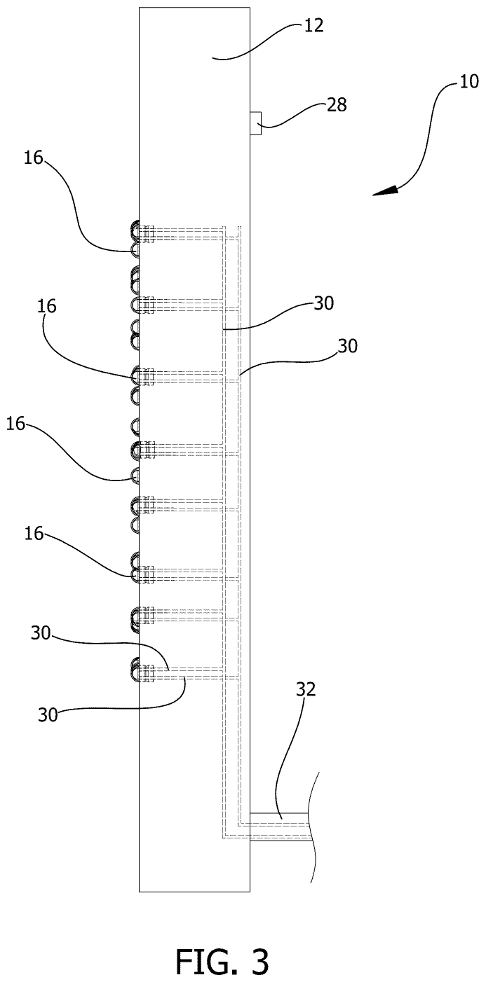

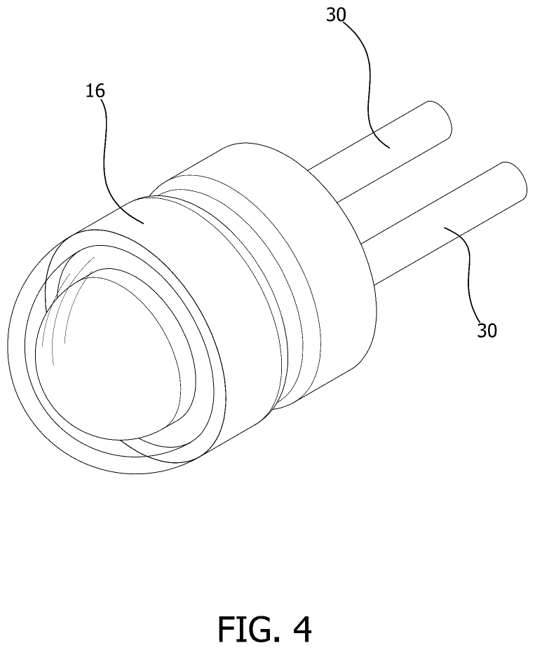

An example of the wiring assembly 14 is shown in FIG. 3, wherein there are a plurality of positive and negative lines 30 connected to the LED bulbs 16, though any suitable wiring assembly is within the disclosure of the application. The wiring assembly 14 is designed to control the operation of the LED bulbs 16 to create a flashing, pulsing, or chaser light effect, as is well known in the lighting arts. The wiring assembly 14 includes power wiring 32 designed to be connected to a power supply, which can be hard wiring or via a power cord 34, such as shown in FIG. 2. FIG. 4 shows an example of an LED bulb 16 with positive and negative lines 30.

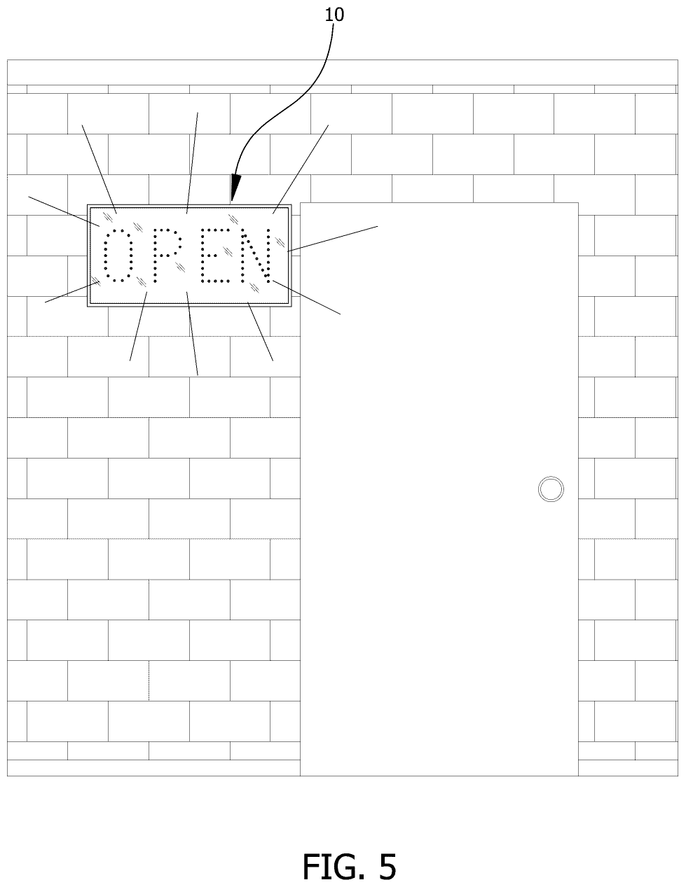

The reflective LED sign 10 can be used for essentially any signage purpose. FIG. 5 shows an example where the reflective LED sign 10 can be used for advertising that a business is open or closed. The reflective surface 24 amplifies the brightness of the LED bulbs 16 or causes an additional glow effect, which thereby can make the reflective LED sign 10 even more visually attractive to viewers, thereby increasing the effectiveness of the reflective LED sign 10 in communicating a message to viewers.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reflective LED sign comprising:
a housing comprising rear panel, side panels, and a front panel, wherein said front panel comprises a reflective surface configured to amplify the brightness of LED bulbs and a plurality of orifices;
a wiring assembly disposed within said housing; and
a plurality of LED bulbs projecting out through said orifices and being operatively connected to said wiring assembly.

2. The reflective LED sign of claim 1, wherein said reflective surface comprises a mirror.

3. The reflective LED sign of claim 1, wherein said orifices are arranged to present a recognizable image.

4. The reflective LED sign of claim 3, wherein said orifices are arranged to present alphanumeric characters.

5. The reflective LED sign of claim 2, wherein said orifices are arranged to present a recognizable image.

6. The reflective LED sign of claim 5, wherein said orifices are arranged to present alphanumeric characters.

7. The reflective LED sign of claim 1, wherein said rear panel comprises a wall mount assembly.

8. The reflective LED sign of claim 1, wherein said wiring assembly is configured to control the operation of said LED bulbs to create a flashing, pulsing, or chaser light effect.

9. The reflective LED sign of claim 1, wherein said wiring assembly comprises power wiring configured to be connected to a power supply.

10. The reflective LED sign of claim 1, wherein said LED bulbs are configured to present at least one color.

11. A reflective LED sign comprising:
a housing comprising rear panel, side panels, and a front panel, wherein said front panel comprises a reflective surface configured to amplify the brightness of LED bulbs and a plurality of orifices, wherein:
said orifices are arranged to present alphanumeric characters,
said reflective surface comprises a mirror,
said rear panel comprises a wall mount assembly;
a wiring assembly disposed within said housing, wherein:
said wiring assembly is configured to control the operation of LED bulbs to create a flashing, pulsing, or chaser light effect,
said wiring assembly comprises power wiring configured to be connected to a power supply; and
a plurality of LED bulbs projecting out through said orifices and being operatively connected to said wiring assembly, wherein said LED bulbs are configured to present at least one color.
